(19) United States
(12) Patent Application Publication
(10) Pub. No.: US 2007/0064200 A1
(43) Pub. Date: Mar. 22, 2007

(54) PROJECTOR

(75) Inventors: Osamu Ishibashi, Suwa-shi, Nagano-ken (JP); Osamu Fujimaki, Suwa-shi, Nagano-ken (JP); Kiyotaka Nakano, Suwa-shi, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/468,582

(22) Filed: Aug. 30, 2006

(30) Foreign Application Priority Data
Sep. 22, 2005 (JP) 2005-275199

(51) Int. Cl. G03B 21/00

(52) U.S. Cl. 353/31

(57) ABSTRACT

A projector that includes: a light source; a integrator illumination optical system that divides a light from the light source into a plurality of luminous fluxes, and superimposes the luminous fluxes on an illumination area using an superimposing lens; a color separation system that separates a light from the superimposing lens into first to third color lights; and first to third light modulation devices that modulate the first to third color lights in accordance with image information. In the projector, an optical path from the superimposing lens to the first light modulation device is equal in length to an optical path from the superimposing lens to the second light modulation device, a first condenser lens is disposed along a light-incident side surface of the first light modulation device, a second condenser lens is disposed along a light-incident side surface of the second light modulation device, the first condenser lens is identical in shape to the second condenser lens, a wavelength region of the first color light is closer to a short-wavelength side than a wavelength region of the second color light, and a distance between the first condenser lens and the first light modulation device is shorter than a distance between the second condenser lens and the second light modulation device.

### BACKGROUND

1. TECHNICAL FIELD

The present invention relates to a projector that projects color images using a light modulation device exemplified by a liquid crystal panel or others.

2. RELATED ART

The projector of a previous type includes an illumination system, guiding a light coming from a light source to three illumination paths for red, green, and blue lights, respectively. The illumination paths for red and green lights are equal in length, and the remaining illumination path for blue light is longer in length than the illumination paths for red and green lights. In such a projector, the illumination path for blue light is formed thereon with a relay optical system configured by two lenses so that the reduction of illuminance is prevented for the blue light, which is often caused by the longer illumination path. For more details, refer to Patent Document 1 (JP-B-2000-241927). The projector of such a type includes a liquid crystal panel for each corresponding color light, and a lens is disposed each along the light-incident side surfaces of the liquid crystal panels.

The problem with such a projector is that a space between the liquid crystal panel for red light and the lens facing thereto is the same as a space between the liquid crystal panel for green light and the lens facing thereto. Due to chromatic aberration of a superimposing lens, an illumination area for red light becomes larger in size than an illumination area for green light. For improvement, the superimposing lens may be designed to make the illumination area for green light fit in the image formation area of the liquid crystal panel. With this being the case, however, the illumination area for red light becomes larger by chromatic aberration than the area fitting the image formation area of the liquid crystal panel, thereby resulting in the reduction of the light use efficiency. What is more, the lenses disposed along the light-incident side surfaces of the liquid crystal panels are also suffering from chromatic aberration. Such chromatic aberration of the lenses varies the illumination areas in size to a further degree depending on the color of light.

### SUMMARY

An advantage of some aspects of the invention is to provide a projector that is capable of, with the fewer number of components, efficiently illuminating a liquid crystal panel provided for each corresponding color light.

The invention is directed to a projector that includes: a light source; a integrator illumination optical system that divides a light from the light source into a plurality of luminous fluxes, and superimposes the luminous fluxes on an illumination area using an superimposing lens; a color separation system that separates a light from the superimposing lens into first to third color lights; and first to third light modulation devices that modulate the first to third color lights in accordance with image information. In this projector, an optical path from the superimposing lens to the first light modulation device is equal in length to an optical path from the superimposing lens to the second light modulation device. A first condenser lens is disposed along a light-incident side surface of the first light modulation device, and a second condenser lens is disposed along a light-incident side surface of the second light modulation device. The first condenser lens is identical in shape to the second condenser lens. A wavelength region of the first color light is closer to a short-wavelength side than a wavelength region of the second color light, and a distance from the first condenser lens to the first light modulation device is shorter than a distance from the second condenser lens to the second light modulation device.

With such a projector, the distance between the first condenser lens and the first light modulation device on the optical path at the short-wavelength side is shorter than the distance between the second condenser lens and the second light modulation device on the optical path at the long-wavelength side. Such a configuration can reduce the influence of chromatic aberration possibly caused when the superimposing lens superimposes the first and second color lights on each other. This accordingly reduces the size difference between the illumination area for projection of the first color light and the illumination area for projection of the second color light so that the light modulation devices provided for their corresponding colors can be illuminated with efficiency. The first and second condenser lenses are the same component of the same shape, thereby reducing the number of components and simplifying the component control. As such, the manufacturing cost for the projector can be favorably reduced.

From a specific side perspective or aspect of the invention, in the projector, a difference between the distance from the first condenser lens to the first light modulation device and the distance from the second condenser lens to the second light modulation device is so set as to equalize the size of the illumination area between the first and second light modulation devices. This configuration can eliminate the size difference between the illumination area for projection of the first color light and the illumination area for projection of the second color light so that the light modulation devices can be illuminated with more efficiency.

In another aspect of the invention, the difference between the distance from the first condenser lens to the first light modulation device and the distance from the second condenser lens to the second light modulation device is 0.5 mm or more but 10 mm, or less. This configuration enables to dispose the condenser lenses not that much away from their corresponding light modulation devices so that the color separation system or others can be disposed in a compact space.

In still another aspect of the invention, in the protector, the integrator illumination optical system includes: a first lens array provided with a plurality of first small lenses that divides the light from the light source into a plurality of luminous fluxes; a second lens array provided with a plurality of second small lenses corresponding to the first small lenses; and the superimposing lens that superimposes the luminous fluxes emitted from the second lens array on the illumination area. With this being the configuration, after adjusting divergence by the second lens array, the luminous fluxes can be directed to the illumination areas provided at the positions of the light modulation devices or the respective colors. The luminous fluxes are of any desired size, and are directed via the superimposing lens.

In still another aspect of the invention, the projector is further provided with: a light combining system that combines lights as a result of modulation in the first to third light modulation devices; and a projection system that projects a light as a result of combination in the light combining system. With such a configuration, an object image can be projected onto a screen as a color image by the projection system. The object image here is a result of combination in the light combining system after formed by the light modulation devices for the respective colors.

### BRIEF DESCRIPTION OF THE DRAWINGS

The invention will be described with reference to the accompanying drawings, wherein like numbers reference like elements.

FIG. 1 is a diagram for illustrating the optical system of a projector of a first embodiment.

FIG. 2 is an enlargement view, for layout description, of a condenser lens provided to a color separation device.

FIGS. 3A and 3B are both a diagram for illustrating the layout relationship between a superimposing lens and condenser lenses.

FIGS. 4A and 4B are both a graph for illustrating the state of illumination between an example and a comparison example.

FIG. 5 is a diagram for illustrating the optical system of a projector of a second embodiment.

### DESCRIPTION OF EXEMPLARY EMBODIMENTS

First Embodiment

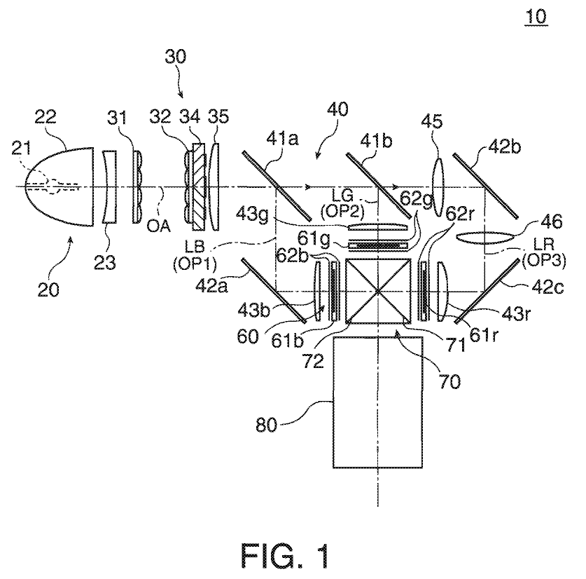

FIG. 1 is a schematic diagram showing the optical system of a projector 10 in a first embodiment of the invention. This projector 10 is an optical instrument that forms an optical image through modulation of luminous fluxes coming from a light source, and magnifies the optical image for projection onto a screen. For modulation of the optical image, image information is used as a basis. The projector 10 is configured to include a light source lamp device 20, a uniform illumination system 30, a color separation device 40, a light modulation section 60, a cross dichroic prism 70, and a projection system 80.

The light source lamp device 20 is a light source serving to illuminate the light modulation section 60 via the uniform illumination system 30 or others. For illumination as such, the light source lamp device 20 collects luminous fluxes emitted around by a light source lamp 21, and directs the luminous fluxes toward the light modulation section 60. The light source lamp device 20 is configured to include the light source lamp 21 being a light-emitting tube, a concave ellipsoidal mirror 22, and a concave lens 23. The concave mirror 22 is provided for reflecting the source light coming from the light source lamp 21, and the concave lens 23 collimates the source light reflected by the concave mirror 22. In such a light source lamp device 20, the source light coming from the light source lamp 21 is collimated after going through the concave mirror 22 and the concave lens 23, and then directed toward the front side, i.e., toward the side of the uniform illumination system 30 for exit. As an alternative to the concave ellipsoidal mirror 22, various other types of concave mirror can be used, e.g., concave parabolic mirror. If with a concave parabolic mirror, the light source lamp device 20 becomes able to emit the collimated luminous fluxes without the concave lens 23 or others subsequent to the concave mirror 22.

The uniform illumination system 30 serves to divide the luminous fluxes from the light source lamp device 20 each into a plurality of partial luminous fluxes, and direct the resulting partial luminous fluxes to any target illumination area. The partial luminous fluxes are superimposed on one another so that the illumination area becomes uniform in illuminance in the plane. The uniform illumination system 30 is configured to include a first lens array 31, a second lens array 32, a polarization conversion member 34, and a superimposing lens 35.

The first lens array 31 serves as an optical element that divides the luminous fluxes coming from the light source lamp 21 each into a plurality of partial luminous fluxes. The first lens array 31 is configured by including a plurality of small lenses, which are disposed in a matrix in the plane orthogonal to a system optical axis OA. These small lenses are each so shaped as to be substantially similar in outline to image formation areas of liquid crystal panels 61b, 61g, and 61r configuring the light modulation section 60, which will be described later. The second lens array 32 serves as an optical element that collects the partial luminous fluxes being the results of division by the first lens array 31, and similarly to the first lens array 31, includes a plurality of small lenses disposed in a matrix in the plane orthogonal to the system optical axis OA. The small lenses of the second lens array are those provided for light collection, and thus are not necessarily similar in outline shape to the image formation areas of the liquid crystal panels 61b, 61g, and 61r.

The polarization conversion member 34 is formed by a PBS array, and serves to direct the partial luminous fluxes through with the second lens array 32 to be aligned in one direction, ie., along the linear polarized light. Although not shown in detail, the polarization conversion member 34 is so configured that a polarization splitter film and a reflection mirror are disposed alternately. The polarization splitter film and the reflection mirror are tilted against the system optical axis OA. The polarization splitter film passes through either a P polarized luminous flux or an S polarized luminous flux for each of the luminous fluxes, and reflects the remaining polarized luminous flux. The reflected polarized luminous flux is bent by the reflection mirror, and is directed toward one of the polarized light directions, i.e., the direction along the system optical axis OA, for exit. The polarized luminous fluxes directed as such are whichever subjected to polarization conversion by a phase difference plate so that every polarized luminous flux is aligned in polarization direction. The phase difference plate is provided in a stripe shape on the luminous-flux-exiting surface of the polarization conversion member 34. Using such a polarization conversion member 34 enables to align the luminous fluxes coming from the light source lamp 21 in one direction so that the source light can be increased in use efficiency for use in the light modulation section 60.

The superimposing lens 35 is an optical element that collects and directs a plurality of partial luminous fluxes to the image formation areas of the liquid crystal panels 61b, 61g, and 61r. The partial luminous fluxes are those through with the first and second lens arrays 31 and 32, and the polarization conversion member 34, and are superimposed on one another on the image formation areas of the liquid crystal panels. The luminous fluxes emitted from the superimposing lens 35 are directed to the color separation device 40 in the subsequent stage while being uniformed. That is, after going through the lens arrays 31 and 32 and the superimposing lens 35, the illumination light reaches the color separation device 40 that will be described below in detail, and then uniformly illuminates the illumination areas of the light modulation sections 60, i.e., the image formation areas of the liquid crystal panels 61b, 61g, and 61r.

The color separation device 40 is configured to include first and second dichroic mirrors 41a and 41b, reflection mirrors 42a, 42b, and 42c, condenser lenses 43r, 43b, and 43g, and relay lenses 45 and 46. Among these components in the color separation system, the first and second dichroic mirrors 41a and 41b separate an illumination light into three luminous fluxes of blue (B) color light, green (G) color light, and red (R) color light. The dichroic mirrors 41a and 41b are each an optical element derived by forming a dielectric multilayer on a transparent substrate. The dielectric multilayer serves for selection of wavelength with which luminous fluxes in a predetermined wavelength region are reflected, and luminous fluxes in any other wavelength regions are passed through. The dichroic mirrors 41a and 42b are both tilted against the system optical axis OA. Out of three color lights of red (R), blue (B), and green (G), the first dichroic mirror 41a reflects a blue light LB, and passes through a green light LG and a red light LR. Out of the incoming green light LG and the red light LR, the second dichroic mirror 41b reflects the green light LG but passes through the red light LR. With the condenser lenses 43r, 43b, and 43g provided on the light-exiting side of the color separation device 40 for the respective colors, the partial luminous fluxes emitted from the second lens array 32 toward the light modulation section 60 show the convergence or divergence of an appropriate level with respect to the system optical axis OA. The pair of relay lenses 45 and 46 is disposed on a third optical path OP3 specifically for the color of red. The third optical oath OP3 is relatively longer than a first optical path OP1 specifically for the color of blue, and a second optical path OP2 specifically for the color of green. With these lenses 45 and 46, an image formed immediately preceding the first relay lens 45 on the light-incident side is transferred substantially as it is to the condenser lens 43r on the light-exiting side. The reduction of light use efficiency is thus prevented, which is often caused by light dissipation or others.

In the color separation device 40, the incoming illumination light provided by the light source lamp device 20 via the uniform illumination system 30 is directed to the first dichroic mirror 41a. The blue light LB reflected by the first dichroic mirror 41a is guided to the first optical path OP1, and then enters the condenser lens 43b in the last stage after going through the reflection mirror 42a. The green light LG reflected by the second dichroic mirror 41b after passing through the first dichroic mirror 41a is guided to the second optical path OP2, and then enters the condenser lens 43g in the last stage. The red light LR is guided to the third optical path OP3 after passing through the second dichroic mirror 41b, and then enters the condenser lens 43r in the last stage after going through the reflection mirrors 42b and 42c, and the relay lenses 45 and 46. Although a detailed description will be given later, the condenser lens 43b for blue light and the condenser lens 43g for green light are both an optical component sharing the same shape and refraction index.

The light modulation section 60 includes the three liquid crystal panels (liquid crystal display panels) 61b, 61g, and 61r, and three sets of polarizer filters 62b, 62g, and 62r. The liquid crystal panels receive, respectively, the three illumination lights of LB, LG, and LR. The polarizer filters 62b are so disposed as to sandwich the liquid crystal panel 61b therebetween, and the remaining polarizer filters 62g and 62r are similarly disposed with respect to the liquid crystal panels 61g and 61r, respectively. Herein, the pair of polarizer filters 62b and 62b configures a liquid crystal light valve together with the liquid crystal panel 61b for the blue light LB therebetween, for example. The resulting liquid crystal light valve subjects the illumination light to two-dimensional brightness modulation based on image information. Similarly thereto, the liquid crystal panel 61g for the green light LG, and its corresponding polarizer filters 62g and 62g configure another liquid crystal valve, and the liquid crystal panel 61r for the red light LR, and its corresponding polarizer filters 62r and 62r configure still another liquid crystal valve. The liquid crystal panels 61b, 61g, and 61r are each configured by a pair of transparent glass substrates with a liquid crystal material sealed therebetween. The liquid crystal material here is an electrooptic material. Using a polysilicon TFT (Thin-Film Transistor) as a switching element, for example, the liquid crystal panels each modulate the incoming luminous fluxes in accordance with any given image signal to direct the luminous fluxes in a specific polarization direction.

In such a light modulation section 60, the blue light LB guided to the first optical path OP1 enters the illumination area at the position of the liquid crystal panel 61b via the condenser lens 43b so that the image formation area in the liquid crystal panel 61b is illuminated. The green light LG guided to the second optical path OP2 enters the illumination area at the position of the liquid crystal panel 61g via the condenser lens 43g so that the image formation area in the liquid crystal panel 61g is illuminated. The red light LR guided to the third optical path OP3 enters the illumination area at the position of the liquid crystal panel 61r via the first and second relay lenses 51 and 52, and the condenser lens 43r so that the image formation area in the liquid crystal panel 61r is illuminated. The liquid crystal panels 61b, 61g, and 61r are each a light modulation device of a non-luminous and transmissive type, provided to change the spatial distribution of the incoming illumination light in the polarization direction. After entering the liquid crystal panels 61b, 61g, and 61r, the polarization states of the color lights LB, LG, and LR are adjusted for every pixel in accordance with a drive signal or a control signal, which is provided as an electric signal to each of the liquid crystal panels 61b, 61g, and 61r. At this time, by the polarization filters 62b, 62g, and 62r, the illumination light entering the liquid crystal panels 61b, 61g, and 61r is adjusted in polarization direction, and any modulated light in predetermined polarization direction is extracted from the light exiting from the liquid crystal panels 61b, 61g, and 61r.

The cross dichroic prism 70 is a light combining system that forms a color image by combining optical images that are modulated for every color light provided by the light-exiting-side polarizer plates 61b, 61g, and 61r. This cross dichroic prism 70 is of subsequently square when viewed from above, made of four right-angle prisms attached together. On one of the interfaces formed by attaching the four right-angle prisms as such, a pair of dielectric multilayer films 71 and 72 is formed in the shape of a letter X. One of the dielectric multilayer films, i.e., first dielectric multilayer film 71, reflects a blue light, and the remaining dielectric multilayer film, i.e., second dielectric multilayer film 72, reflects a red light. With such a cross dichroic prism 70, the blue light LB from the liquid crystal panel 61b is reflected by the first dielectric multilayer film 71, and is directed toward the right side in the traveling direction of the light for exit therefrom. The green light LG from the liquid crystal panel 61g is made to go straight for exit via the first and second dielectric multilayer films 71 and 72, and the red light LR from the liquid crystal panel 61r is reflected by the second dielectric multilayer film 72, and is directed toward the left side in the traveling direction of the light for exit therefrom.

The object image being a result of combination by the cross dichroic prism 70 as such first goes through the projection system 80 serving as a magnifier lens, and then is projected on a screen (not shown) as a color image with any appropriate magnification.

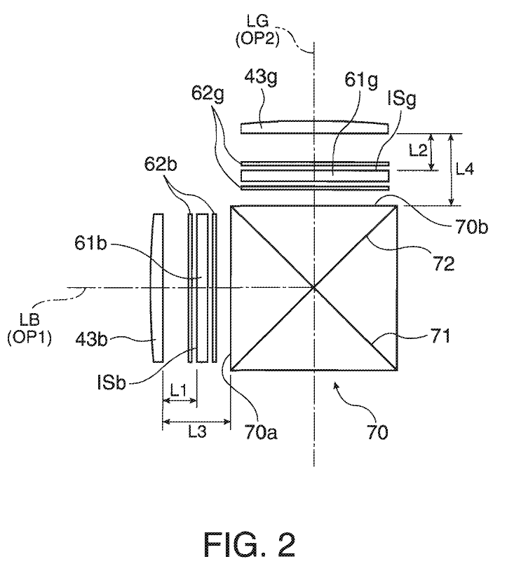

FIG. 2 is an enlargement view of a condenser lens 43b, 43g provided to the color separation device 40 for layout description. On the first optical path OP1 for blue light, the condenser lens 43b is so disposed as to face and along a light-incident side surface ISb of the liquid crystal panel 61b. The liquid crystal panel 61b is so disposed as to face and along a side surface 70a of the cross dichroic prism 70. Herein, the distance between the condenser lens 43b and the liquid crystal panel 61b is denoted by L1, and the distance between the condenser lens 43b and the side surface 70a is denoted by L3. The distance L1 is related to the size of the illumination area of the liquid crystal panel 61b, into which the blue light LB enters via the condenser 43b after passing through the superimposing lens 35. Through adjustment of this distance L1, the image formation area of the liquid crystal panel 61b can be illuminated uniformly with efficiency.

On the second optical path OP2 for green light, the condenser lens 43g is so disposed as to face and along a light-incident side surface ISg of the liquid crystal panel 61g. The liquid crystal panel 61g is so disposed as to face and along a side surface 70b of the cross dichroic prism 70. Herein, the distance between the condenser lens 43g and the liquid crystal panel 61g is denoted by L2, and the distance between the condenser lens 43g and the side surface 70b is denoted by L4. The distance L2 is related to the size of the illumination area of the liquid crystal panel 61g, into which the green light LG enters via the condenser 43g after passing through the superimposing lens 35. Through adjustment of this distance L2, the image formation area of the liquid crystal panel 61g can be illuminated uniformly with efficiency.

With such a configuration, the condenser lens 43b is disposed relatively close to the liquid crystal panel 61b, and the condenser lens 43g is disposed relatively away from the liquid crystal panel 61g, thereby establishing the relationship of L1<L2. If the space between the liquid crystal panel 61b and the side surface 70a of the cross dichroic prism 70 is equal to the space between the liquid crystal panel 61g and the side surface 70b of the cross dichroic prism 70, the relationship of L3<L4 can be also established.

The difference X between the distance L1 from the condenser lens 43b to the liquid crystal panel 61b and the distance L2 from the condenser lens 43g to the liquid crystal panel 61g, i.e., X=L2−L1, is so set as make the liquid crystal panel 61b for the blue light LB equal in size of the illumination area to the liquid crystal panel 61g for the green light LG. Herein, the distance difference X is preferably 0.5 mm or more but 10 mm or less. Such a distance setting enables to dispose the condenser lenses 43b and 43g not away that much from their corresponding liquid crystal panels 61b and 61g so that the color separation device 40 or others can be disposed in a compact space.

When the space between the liquid crystal panel 61b and the side surface 70a of the cross dichroic prism 70 is equal to the space between the liquid crystal panel 61g and the side surface 70b of the cross dichroic prism 70, with the distance difference X=L2−L1=L4−L3, the liquid crystal panel 61b for the blue light LB can be made equal in size of the illumination area to the liquid crystal panel 61g for the green light LG by adjusting the distance from the side surfaces 70a and 70b of the cross dichroic prism 70 for the condenser lenses 43b and 43g.

Exemplified here is an optical system in which consideration is given to chromatic aberration possibly caused by the components disposed on the light-exiting-side optical paths for the liquid crystal panels 61r, 61g, and 61b, i.e., the cross dichroic prism 70, the polarization filters 62r, 62g, and 62b, and the projection system 80. In such a case, for the purpose of correcting the chromatic aberration, the liquid crystal panels 61r, 61g, and 61b are disposed with each different space from the side surfaces of the cross dichroic prism 70. In consideration thereof, the condenser lenses 43g and 43b are each adjusted by distance from their corresponding liquid crystal panels 61g and 61b so that the liquid crystal panel 61b for the blue light LB is made equal in size of the illumination area to the liquid crystal panel 61g for the green light LG.

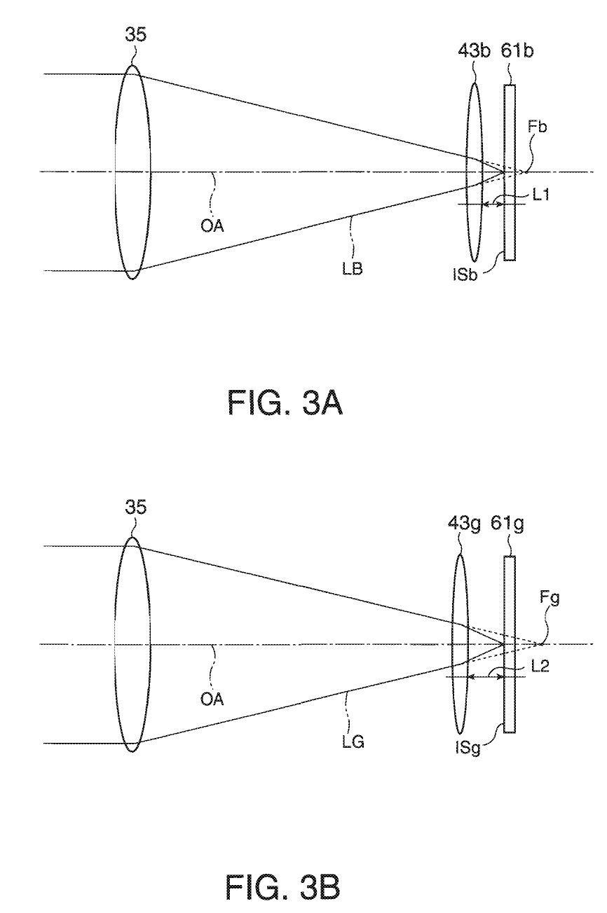

FIGS. 3A and 3B are both a diagram for illustrating the layout relationship between the superimposing lens 35 and the condenser lenses 43b and 43g. FIG. 3A shows the layout and light collection state of the condenser lens 43b, and FIG. 3B shows the layout and light collection state of the condenser lens 43g. The condenser lens 43b of FIG. 3A is disposed relatively away from the liquid crystal panel 61b for blue light, and the condenser lens 43g of FIG. 3B is disposed relatively close to the liquid crystal panel 61g for green light. The superimposing lens 35 is suffering from chromatic aberration, and converges the blue light LB collimated along the system optical axis OA at a focal point Fb. The focal point Fb is located behind and relatively close to the liquid crystal panel 61b. The superimposing lens 35 converges the green light LG collimated along the system optical axis OA at a focal point Fg, which is located behind and relatively away from the liquid crystal panel 61g. As described in the foregoing, however, the blue light LB collimated along the system optical axis OA can be collected on the light-incident side surface ISb of the liquid crystal panel 61b, and the green light LG collimated along the system optical axis OA can be collected on the light-incident side surface ISg of the liquid crystal panel 61g through appropriate distance setting. That is, a value setting is made as appropriate to the distance L1 between the condenser lens 43b and the liquid crystal panel 61b, and the distance L2 between the condenser lens 43g and the liquid crystal panel 61g, specifically L2−L1=0.5 to 10 mm. That is, the blue light LB and the green light LG share substantially the same focal point and optical magnification. This enables the blue light LB and the green light LG to enter their corresponding liquid crystal panels 61b and 61g with accurate superimposed light so that the illumination area for the blue light LB is made equal in size to that for the green light LG. As such, efficient and uniform illumination is achieved at least with the blue light LB and the green light LG. The condenser lens 43b for blue light share the same component of the same shape with the condenser lens 43g for green light, thereby reducing the number of components and simplifying the component control. As such, the manufacturing cost for the projector 10 can be favorably reduced.

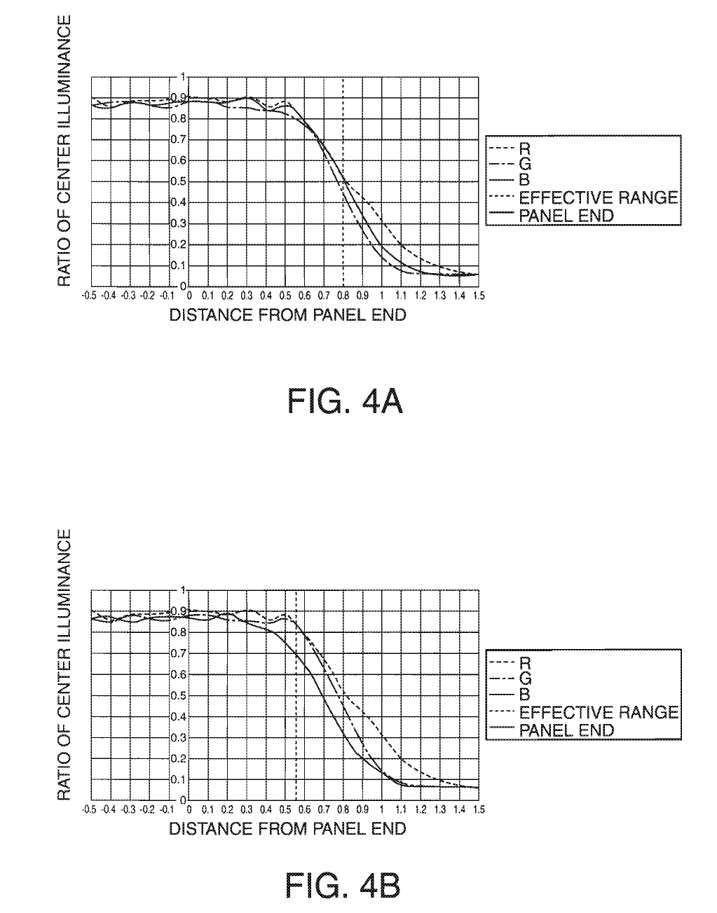

FIG. 4A is a graph for illustrating exemplary state of illumination for the projector 10 of the embodiment, and FIG. 4B is a graph for illustrating another exemplary state of illumination for a projector provided for comparison purpose.

With the state of illumination for the projector 10, the colors of blue, green, and red show the same illumination distribution on the outer end sides of the liquid crystal panels in the wide range. As such, the color balance remains good, and this tells that the illumination area available for effective use is reserved about 0.8 mm from the reference point, which is equivalent to the end of the corresponding liquid crystal panel. On the other hand, with the state of illumination for another projector for comparison, the illumination distribution for the color of blue is considerably different from those for the colors of green and red on the outer end sides of the liquid crystal panels. This tells that the illumination area available for effective use is reserved only about 0.5 mm from the reference point, which is equivalent to the end of the corresponding liquid crystal panel. In the comparison example, the distance from the condenser lens 43b for blue light to the liquid crystal panel 61b is made equal to the distance from the condenser lens 43g for green light to the liquid crystal panel 61g. As such, obviously, by adjusting the positions of the condenser lenses 43b and 43g with respect to their corresponding liquid crystal panels 61b and 61g, the liquid crystal panel 61b for the blue light LB can be made equal in size of the illumination area to the liquid crystal panel 61g for the green light LG. This successfully enables to efficiently illuminate the liquid crystal panels 61b and 61g with less color inconsistencies.

Second Embodiment

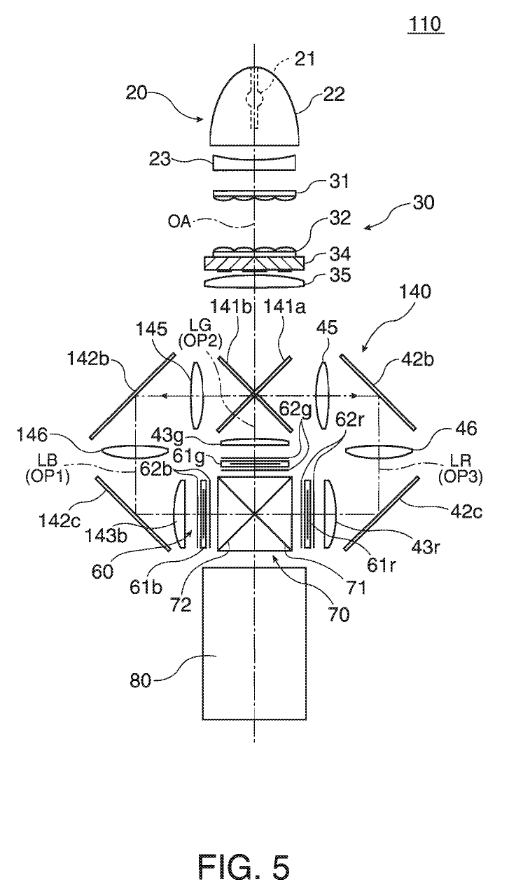

FIG. 5 is a diagram for illustrating a projector 110 of a second embodiment. The projector 110 is partially different from the projector 10 of FIG. 1 in the first embodiment. Any components not specifically described are of the same configuration as those in the projector 10 of the first embodiment, and any identical components are provided with the same reference numerals and not described again.

The projector 110 of the second embodiment is provided with a color separation device 140, which is a modified version of the color separation device 40 of FIG. 1.

In the color separation device 140, an illumination light coming from the side of the uniform illumination system 30 enters a cross dichroic mirror, which is configured by a pair of first and second dichroic mirrors 141a and 141b formed in the shape of a letter X. The blue light LB reflected by the first dichroic mirror 141a is guided to the first optical path OP1, and enters a condenser lens 143b after passing through reflection mirrors 142b and 142c, and relay lenses 145 and 146. The green light LG goes straight after passing through the first and second dichroic mirrors 141a and 141b, and then enters the condenser lens 43g after being guided to the second optical path OP2. The red light LR reflected by the second dichroic mirror 141b is guided to the third optical path OP3, and enters the condenser lens 43r after passing through the reflection mirrors 42b and 42c, and the relay lenses 45 and 46.

Herein, the relay lenses 145 and 146 are the same as the relay lenses 45 and 46, and the condenser lens 143b is also the same as the condenser lens 43r. By using any same components as such, the manufacturing cost for the projector can be favorably reduced. The condenser lens 143b for short wavelengths is disposed relatively close to the liquid crystal panel 61b, and the condenser lens 43r for long wavelengths is disposed relatively away from the liquid crystal panel 61r. With such a configuration, the liquid crystal panel 61b for the blue light LB is made equal in size of the illumination area to the liquid crystal panel 61r for the red light LR.

While the invention has been described in detail, the foregoing description is in all aspects illustrative and not restrictive. It is understood that numerous other modifications as below, for example, can be devised without departing from the scope of the invention.

That is, in the embodiments, the condenser lenses 43b and 43g are each formed concave on one surface but flat on the other surface. This is surely not restrictive, and various other lenses can serve as the condenser lenses 43b and 43g, e.g., lens formed concave on both surfaces.

In the embodiments, the red light LR is guided to the third optical path OP3 that is relatively long, and the third optical path OP3 carries thereon the relay optical systems 45 and 46. Alternatively, the blue or green light LB or LG may be guided to such a long optical path OP3. With this being the case, the blue or green light is transferred to its corresponding liquid crystal panel by the relay optical systems 45 and 46. The space between the condenser lens disposed on the optical path for red light and the liquid crystal panel is wider than the space between the condenser lens disposed on the optical path for blue or green light and the liquid crystal panel. As such, the liquid crystal panels for the respective colors can each have the same-sized illumination area.

In the embodiments, exemplified is the case of combining together the liquid crystal panels provided for three colors. The same is applicable to a case of combining together liquid crystal panels for four colors, e.g., red, blue, green, and yellow. Also in this case, the condenser can be each disposed on the optical paths for any two or more equivalent color lights, and the space between the condenser lens and the corresponding liquid crystal panel can be increased or decreased depending on the wavelength of the corresponding optical path.

In the embodiments, the two lens arrays 31 and 32 are used for dividing a light coming from the light source lamp device 20 into a plurality of luminous fluxes. The invention is applicable also to a projector using no such lens array The lens arrays 31 and 32 can be replaced with a rod integrator.

The projector 10 uses the polarization conversion member 34 in which a light from the light source lamp device 20 is regarded as the polarized light in a specific direction. This is not restrictive, and the invention is applicable also to a projector using no such polarization conversion member 34.

In the embodiments, exemplified is the case of applying the invention to the projector of a transmissive type. This is not the only possibility, and the invention is applicable also to a projector of a reflection type. Herein, the “transmissive type” means that a light valve including a liquid crystal panel or others passes through the light, and the “reflection type” means that the light valve reflects the light. With the projector of a reflection type, the light valve can be configured only by a liquid crystal panel, and requires no pair of polarization plates.

The projector includes a front projector that performs image projection from the direction observing the protection surface, and a rear projector that performs image projection from the opposite side of observing the projection surface. The projector 10 of FIGS. 1, and 4A and 4B can be either a front or rear projector in terms of configuration.

Further, while this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

The priority applications Numbers JP2005-275199 upon which this patent application is based is hereby incorporated by reference.

What is claimed is:

1. A projector, comprising:
a light source;
an integrator illumination optical system that divides a light from the light source into a plurality of luminous fluxes, and superimposes the luminous fluxes on an illumination area using a superimposing lens;
a color separation system that separates a light from the superimposing lens into first to third color lights;
first to third light modulation devices that modulate the first to third color lights in accordance with image information,
a first condenser lens disposed along a light-incident side surface of the first light modulation device, and
a second condenser lens disposed along a light-incident side surface of the second light modulation device,
an optical path from the superimposing lens to the first light modulation device being equal in length to an optical path from the superimposing lens to the second light modulation device,
the first condenser lens being identical in shape to the second condenser lens,
a wavelength region of the first color light being closer to a short-wavelength side than a wavelength region of the second color light, and
a distance between the first condenser lens and the first light modulation device being shorter than a distance between the second condenser lens and the second light modulation device.

2. The projector according to claim 1,
a difference between the distance from the first condenser lens to the first light modulation device and the distance from the second condenser lens to the second light modulation device being set to equalize a size of the illumination area between the first and second light modulation devices.

3. The projector according to claim 2,
the difference between the distance from the first condenser lens to the first light modulation device and the distance from the second condenser lens to the second light modulation device being 0.5 mm or more but 10 mm or less.

4. The projector according to claim 1,
the integrator illumination optical system including:
a first lens array provided with a plurality of first small lenses that divides the light from the light source into the plurality of luminous fluxes;
a second lens array provided with a plurality of second small lenses corresponding to the first small lenses; and
the superimposing lens that superimposes the luminous fluxes emitted from the second lens array on the Illumination area.

5. The projector according to claim 1, further comprising:
a light combining system that combines lights as a result of modulation in the first to third light modulation devices; and
a projection system that projects a light as a result of combination in the light combining system.
